(19) United States
(12) Patent Application Publication
(10) Pub. No.: US 2016/0236456 A1
(43) Pub. Date: Aug. 18, 2016

(54) METHOD OF ADHERING ETHYL VINYL ACETATE COPOLYMER OR DERIVATIVE THEREOF LAYER TO THERMOPLASTIC ELASTOMER LAYER AND LAMINATE

(71) Applicant: aePlasma 41 Co., Ltd., Taoyuan City (TW)

(72) Inventors: Chia-Chiang CHANG, Taoyuan City (TW); Han-Chung LAI, Taoyuan City (TW)

(21) Appl. No.: 15/016,285

(22) Filed: Feb. 5, 2016

Related U.S. Application Data
(60) Provisional application No. 62/116,930, filed on Feb. 17, 2015.

(30) Foreign Application Priority Data
Feb. 4, 2016 (TW) 105103799

(51) Int. Cl. B32B 38/00; B32B 27/08; B32B 37/12; B32B 27/30

(52) U.S. Cl. CPC B32B 38/0008; B32B 27/306; B32B 27/08; B32B 37/12; B32B 2310/14; B32B 2255/10; B32B 2331/04

(57) ABSTRACT

A method of adhering an ethyl vinyl acetate copolymer or a derivative thereof layer to a thermoplastic elastomer layer includes providing the ethyl vinyl acetate copolymer or the derivative thereof layer; performing a first atmospheric environmental plasma treatment on a surface of the ethyl vinyl acetate copolymer or the derivative thereof layer to form a first modified surface; providing the thermoplastic elastomer layer; performing a second atmospheric environmental plasma treatment on a surface of the thermoplastic elastomer layer to form a second modified surface; forming an adhesive layer over the first modified surface, the second modified surface, or the first modified surface and the second modified surface; and adhering the first modified surface to the second modified surface through the adhesive layer.

### RELATED APPLICATIONS

This application claims the priority benefit of U.S. provisional application Ser. No. 62/116,930, filed Feb. 17, 2015, and Taiwan application serial No. 105103799, filed on Feb. 4, 2016. The entirety of the above-mentioned patent application are hereby incorporated by reference herein and made a part of specification.

### BACKGROUND

1. Field of Invention

The present disclosure relates to a method of adhering an ethyl vinyl acetate copolymer or a derivative thereof layer to a thermoplastic elastomer layer, and a laminate.

2. Description of Related Art

Generally, it is not easy to adhere ethyl vinyl acetate copolymer to thermoplastic elastomer through a single adhesive layer. Therefore, there is a need of primers respectively formed over the ethyl vinyl acetate copolymer and the thermoplastic elastomer to change their surface properties and thus to help subsequent adhesion. However, development of the primers is not easy, and cost thereof is extremely high, and the primers have toxicity. Accordingly, there is a need of a novel adhesion method to effectively adhere the ethyl vinyl acetate copolymer to the thermoplastic elastomer without using primers, so as to reduce cost of associated product applications and meet environmental requirements.

### SUMMARY

A purpose of the present disclosure is to provide a novel adhesion method to effectively adhere the ethyl vinyl acetate copolymer to the thermoplastic elastomer without using primers.

The present disclosure provides a method of adhering an ethyl vinyl acetate copolymer or a derivative thereof layer to a thermoplastic elastomer layer includes providing the ethyl vinyl acetate copolymer or the derivative thereof layer; performing a first atmospheric environmental plasma treatment on a surface of the ethyl vinyl acetate copolymer or the derivative thereof layer to form a first modified surface; providing the thermoplastic elastomer layer; performing a second atmospheric environmental plasma treatment on a surface of the thermoplastic elastomer layer to form a second modified surface; forming an adhesive layer over the first modified surface, the second modified surface, or the first modified surface and the second modified surface; and adhering the first modified surface to the second modified surface through the adhesive layer.

According to one embodiment of the present disclosure, a gas of the first atmospheric environmental plasma treatment and a gas of the second atmospheric environmental plasma treatment are selected from the group consisting of air, nitrogen, oxygen, argon, carbon dioxide and a combination thereof.

According to one embodiment of the present disclosure, five seconds before performing the first atmospheric environmental plasma treatment and five seconds after performing the first atmospheric environmental plasma treatment, each of the surface of the ethyl vinyl acetate copolymer or the derivative thereof layer and the first modified surface has a temperature less than or equal to 70° C., and five seconds before performing the second atmospheric environmental plasma treatment and five seconds after performing the second atmospheric environmental plasma treatment, each of the surface of the thermoplastic elastomer layer and the second modified surface has a temperature less than or equal to 150° C.

According to one embodiment of the present disclosure, the adhesive layer includes a material selected from the group consisting of acrylic resin, epoxy resin, hot melt adhesive, polyurethane, organic silicon and a combination thereof.

According to one embodiment of the present disclosure, an adhesive strength of the first modified surface to the second modified surface through the adhesive layer is greater than or equal to 2 kg/cm.

According to one embodiment of the present disclosure, the method further includes heating the adhesive layer before adhering the first modified surface to the second modified surface through the adhesive layer.

The present disclosure further provides a laminate manufactured by the method mentioned above, in which the laminate is consisting essentially of the ethyl vinyl acetate copolymer or the derivative thereof layer, the thermoplastic elastomer layer and the adhesive layer.

The present disclosure further provides a laminate consisting essentially of an ethyl vinyl acetate copolymer or the derivative thereof layer, a thermoplastic elastomer layer and an adhesive layer, in which the thermoplastic elastomer layer is on a side of the ethyl vinyl acetate copolymer or the derivative thereof layer, and the adhesive layer is between the ethyl vinyl acetate copolymer or the derivative thereof layer and the thermoplastic elastomer layer.

According to one embodiment of the present disclosure, each of a surface of the ethyl vinyl acetate copolymer or the derivative thereof layer and a surface of the thermoplastic elastomer layer has a functional group selected from the group consisting of a hydroxyl group, a carbonyl group, a carboxyl group, an aldehyde group, an amino group and a combination thereof.

According to one embodiment of the present disclosure, an adhesive strength of the ethyl vinyl acetate copolymer or the derivative thereof layer to the thermoplastic elastomer layer through the adhesive layer is greater than or equal to 2 kg/cm.

### BRIEF DESCRIPTION OF THE DRAWINGS

The invention can be more fully understood by reading the following detailed description of the embodiment, with reference made to the accompanying drawings as follows:

FIGS. 1-4 are cross-sectional views at various stages of adhering an ethyl vinyl acetate copolymer or a derivative thereof layer to a thermoplastic elastomer layer in accordance with some embodiments of the present disclosure.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

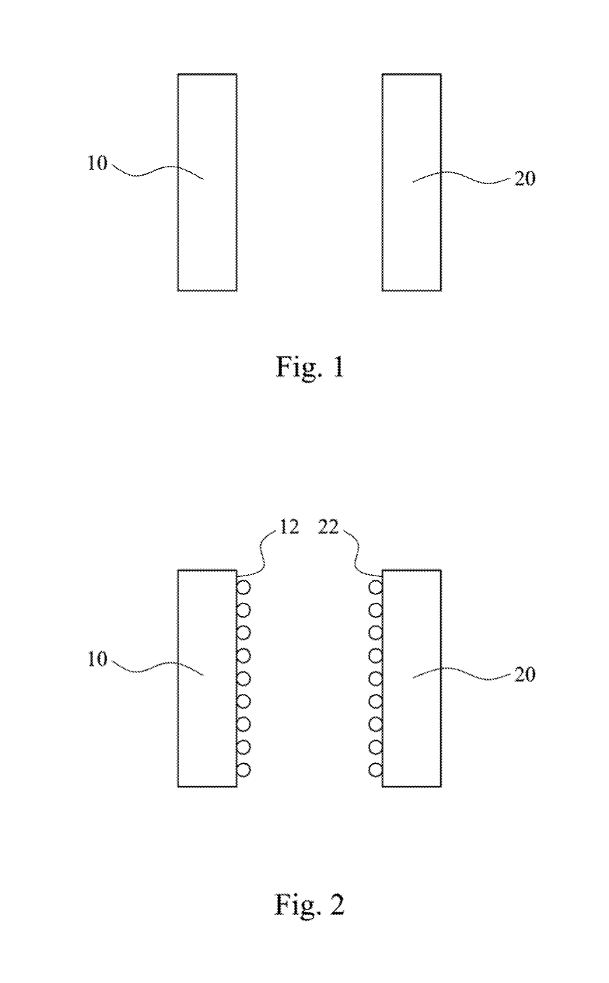

The present disclosure provides a method of adhering an ethyl vinyl acetate copolymer or a derivative thereof layer to a thermoplastic elastomer layer. FIGS. 1-4 are cross-sectional views at various stages of adhering an ethyl vinyl acetate copolymer or a derivative thereof layer to a thermoplastic elastomer layer in accordance with some embodiments of the present disclosure.

As shown in FIG. 1, the ethyl vinyl acetate copolymer or the derivative thereof layer 10 is provided. The term “derivative of the ethyl vinyl acetate copolymer” herein refers to other copolymers that hydrogen atom(s) or atomic group(s) of the ethyl vinyl acetate copolymer is replaced by other atom(s) or atomic group(s). For example, the ethylene repeating unit of the ethyl vinyl acetate copolymer and/or the vinyl acetate repeating unit thereof can be replaced by other atom(s) or atomic group(s), such as replaced by a halogen atom (e.g., fluorine atom, chlorine atom), a hydroxyl group or an alkyl group (e.g., C1-C4 alkyl group).

The “derivative of the ethyl vinyl acetate copolymer” may include a specific amount of the vinyl acetate. For example, the derivative of the ethyl vinyl acetate copolymer may have an amount of the vinyl acetate less than or equal to 5 wt %, 5 to 10 wt %, 20 to 28 wt % or 5 to 45 wt %.

As shown in FIG. 1, the thermoplastic elastomer layer 20 is provided. The term “thermoplastic elastomer” herein may also be called as thermoplastic rubber, which is a copolymer or a physical mixing of polymers (usually plastic and rubber), and thus includes both thermoplastic properties and elastomer properties. The “thermoplastic elastomer” may be styrenic block copolymers (TPE-s), polyolefins, polyolefin blends, elastomeric alloys (TPE-v or TPV), thermoplastic polyurethanes (TPU), thermoplastic copolyesters, thermoplastic polyamides or a combination thereof. For example, the styrenic block copolymers may be styrene-butadiene-styrene block copolymer (SBS); styrene-isoprene-styrene block copolymer (SIS); styrene-ethylene-butylene-styrene block copolymer (SEBS); styrene-ethylene-propylene-styrene block copolymer (SEPS). The polyolefins may be cis-1,4-butadiene rubber (BR).

As shown in FIG. 2, a first atmospheric environmental plasma treatment is performed on the ethyl vinyl acetate copolymer or the derivative thereof layer 10 to form a first modified surface 12. Each of the “first atmospheric environmental plasma treatment” herein and the “second atmospheric environmental plasma treatment” hereafter refers to a plasma treatment performed under an atmospheric environment. That is, the plasma treatment is performed under the atmospheric environment with 1 atm (101.325 Pascal) or close to 1 atm.

In some embodiments, a gas of the first atmospheric environmental plasma treatment is selected from the group consisting of air, nitrogen, oxygen, argon, carbon dioxide and a combination thereof. In some embodiments, five seconds before performing the first atmospheric environmental plasma treatment and five seconds after performing the first atmospheric environmental plasma treatment, each of the surface predetermined to be treated and the formed first modified surface 12 has a temperature less than or equal to 70° C. In some embodiments, a power of the first atmospheric environmental plasma treatment is in a range of 100 W to 1,000 W. In some embodiments, the first modified surface 12 includes a functional group (i.e., the circular element over the first modified surface 12 of FIG. 2) selected from the group consisting of a hydroxyl group, a carbonyl group, a carboxyl group, an aldehyde group, an amino group and a combination thereof. It is because in the plasma gas, such as air and oxygen, the oxygen atom and the oxygen atom having free radicals can be grafted to the atom (e.g., —C—O—O.) of the ethyl vinyl acetate copolymer or the derivative thereof layer 10 to form the hydroxyl group, the carbonyl group, the carboxyl group, the aldehyde group or the amino group.

As shown in FIG. 2, a second atmospheric environmental plasma treatment is performed on a surface of the thermoplastic elastomer layer 20 to form a second modified surface 22. In some embodiments, a gas of the second atmospheric environmental plasma treatment is selected from the group consisting of air, nitrogen, oxygen, argon, carbon dioxide and a combination thereof. In some embodiments, five seconds before performing the second atmospheric environmental plasma treatment and five seconds after performing the second atmospheric environmental plasma treatment, each of the surface predetermined to be treated and the second modified surface 22 has a temperature less than or equal to 150° C. In some embodiments, a power of the second atmospheric environmental plasma treatment is in a range of 100 W to 1,000 W. In some embodiments, the second modified surface 22 includes a functional group (i.e., the circular element over the second modified surface 22 of FIG. 2) selected from the group consisting of a hydroxyl group, a carbonyl group, a carboxyl group, an aldehyde group, an amino group and a combination thereof. It is because in the plasma gas, such as air and oxygen, the oxygen atom and the oxygen atom having free radicals can be grafted to the atom (e.g., —C—O—O.) of the thermoplastic elastomer layer 20 to form the hydroxyl group, the carbonyl group, the carboxyl group, the aldehyde group, the amino group or the combination thereof.

In some embodiments, each of the first modified surface 12 and the second modified surface 22 has a surface energy greater than or equal to 50 mN/m, even greater than 60 mN/m or 70 mN/m. In some embodiments, the ethyl vinyl acetate copolymer or the derivative thereof layer 10 without performing the first atmospheric environmental plasma treatment has a surface energy of about 29 mN/m, and the thermoplastic elastomer layer 20 without performing the second atmospheric environmental plasma treatment has a surface energy of about 29 mN/m.

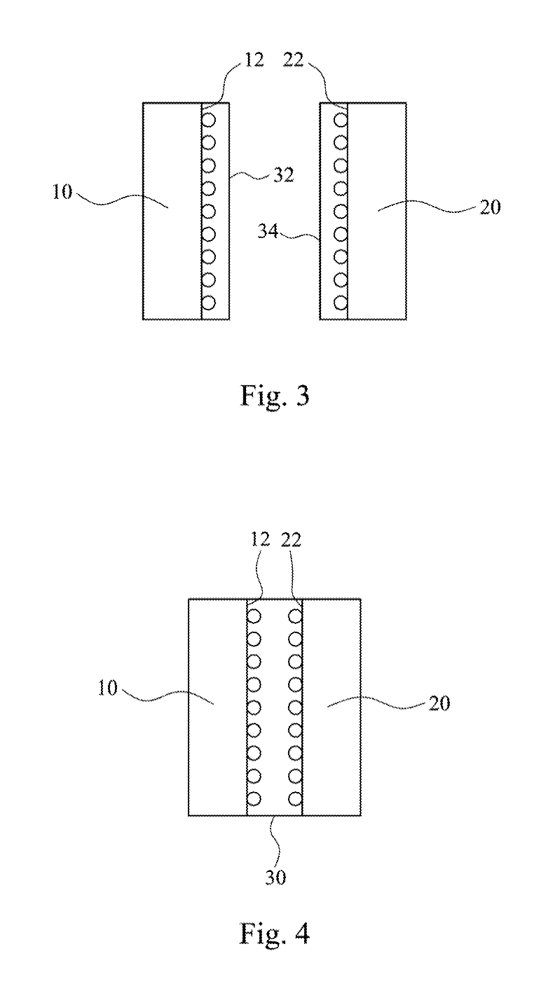

Subsequently, an adhesive layer is formed over the first modified surface 12, the second modified surface 22, or the first modified surface 12 and the second modified surface 22. In some embodiments, as shown in FIG. 3, a first adhesive layer 32 and a second adhesive layer 34 are respectively formed over the first modified surface 12 and the second modified surface 22. In other embodiments, the first adhesive layer 32 or the second adhesive layer 34 can only be formed. Each of the first adhesive layer 32 and the second adhesive layer 34 includes a material selected from the group consisting of acrylic resin, epoxy resin, hot melt adhesive, polyurethane, organic silicon and a combination thereof. The acrylic resin, such as cyanoacrylate resin, can also be called as a quick adhesive. The polyurethane can be aqueous polyurethane or oily polyurethane.

After the first adhesive layer 32 and the second adhesive layer 34 are formed, the first modified surface 12 is adhered to the second modified surface 22 through the first adhesive layer 32 and the second adhesive layer 34. In some embodiments, the material of the first adhesive layer 32 is the same as the material of the second adhesive layer 34, and thus after adhesion, as shown in FIG. 4, an interface between the first adhesive layer 32 and the second adhesive layer 34 is disappeared, and the first adhesive layer 32 and the second adhesive layer 34 are merged to form an adhesive layer 30.

In some embodiments, an adhesive strength of the first modified surface 12 to the second modified surface 22 through the adhesive layer 30 is greater than or equal to 4 kg/cm, even greater than or equal to 5 kg/cm, 6 kg/cm, 7 kg/cm, 8 kg/cm, 9 kg/cm or 10 kg/cm.

In some embodiments, before adhering the first modified surface 12 to the second modified surface 22 through the first adhesive layer 32 and the second adhesive layer 22, the first adhesive layer 32 and/or the second adhesive 34 are/is heated to help adhesion between the first adhesive layer 32 and the second adhesive layer 34.

The present disclosure also provides a laminate manufactured by the method mentioned above, in which the laminate is consisting essentially of an ethyl vinyl acetate copolymer or the derivative thereof layer 10, a thermoplastic elastomer layer 20 and an adhesive layer 30, as shown in FIG. 4.

The present disclosure further provides a laminate, as shown in FIG. 4, which is consisting essentially of an ethyl vinyl acetate copolymer or the derivative thereof layer 10, a thermoplastic elastomer layer 20 and an adhesive layer 30. The thermoplastic elastomer layer 20 is on a side of the ethyl vinyl acetate copolymer or the derivative thereof layer 10, and the adhesive layer 30 is between the ethyl vinyl acetate copolymer or the derivative thereof layer 10 and the thermoplastic elastomer layer 20.

In some embodiments, the laminate is consisting of the ethyl vinyl acetate copolymer or the derivative thereof layer 10, the thermoplastic elastomer layer 20 and the adhesive layer 30.

In some embodiments, as shown in FIG. 4, each of the surface 12 of the ethyl vinyl acetate copolymer or the derivative thereof layer 10 adjacent to the adhesive layer 30 and the surface 22 of the thermoplastic elastomer layer 20 adjacent to the adhesive layer 30 includes a functional group selected from the group consisting of a hydroxyl group, a carbonyl group, a carboxyl group, an aldehyde group, an amino group and a combination thereof.

In some embodiments, an adhesive strength of the ethyl vinyl acetate copolymer or the derivative thereof layer 10 of the laminate to the thermoplastic elastomer layer 20 of the laminate is greater than or equal to 4 kg/cm, or even greater than or equal to 5 kg/cm, 6 kg/cm, 7 kg/cm, 8 kg/cm, 9 kg/cm or 10 kg/cm.

### EXAMPLES

The following Examples are provided to illustrate certain aspects of the present disclosure and to aid those of skill in the art in practicing this disclosure. These Examples are in no way to be considered to limit the scope of the disclosure in any manner.

### Example 1

An ethyl vinyl acetate copolymer layer and a styrene-butadiene-styrene block copolymer layer were obtained. A first atmospheric environmental plasma treatment was performed on a surface of the ethyl vinyl acetate copolymer layer to form a first modified surface. Five seconds before performing the first atmospheric environmental plasma treatment and five seconds after performing the first atmospheric environmental plasma treatment, each of the surface and the formed first modified surface had a temperature less than or equal to 70° C. The gas of the first atmospheric environmental plasma treatment was air with pressure of 1 atm, and the plasma power was 500 W.

A second atmospheric environmental plasma treatment was performed on a surface of the styrene-butadiene-styrene block copolymer layer to form a second modified surface. Five seconds before performing the second atmospheric environmental plasma treatment and five seconds after performing the second atmospheric environmental plasma treatment, each of the surface and the formed second modified surface had a temperature less than or equal to 150° C. The gas of the second atmospheric environmental plasma treatment was air with pressure of 1 atm, and the plasma power was 500 W. The first modified surface had a surface energy of 72 mN/m. The second modified surface had a surface energy of 72 mN/m.

Subsequently, a first adhesive layer was formed over the first modified surface. A second adhesive layer was formed over the second modified surface. The material of the first adhesive layer was an aqueous polyurethane. The material of the second adhesive layer was the aqueous polyurethane. The first adhesive layer was adhered to the second adhesive layer to form a laminate of FIG. 4. An adhesive strength test was performed on the laminate to obtain an adhesive strength between the ethyl vinyl acetate copolymer layer and the styrene-butadiene-styrene block copolymer layer of 9 kg/cm.

### Comparative Example 1

A laminate was obtained, which is a stacked structure of ethyl vinyl acetate copolymer layer/first primer/adhesive layer/second primer/styrene-butadiene-styrene block copolymer layer. An adhesive strength test was performed on the laminate to obtain an adhesive strength between the ethyl vinyl acetate copolymer layer and the styrene-butadiene-styrene block copolymer layer of about 3 kg/cm, which was much lower than that of Example 1.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A method of adhering an ethyl vinyl acetate copolymer or a derivative thereof layer to a thermoplastic elastomer layer, the method comprising:
providing the ethyl vinyl acetate copolymer or the derivative thereof layer;
performing a first atmospheric environmental plasma treatment on a surface of the ethyl vinyl acetate copolymer or the derivative thereof layer to form a first modified surface;
providing the thermoplastic elastomer layer;
performing a second atmospheric environmental plasma treatment on a surface of the thermoplastic elastomer layer to form a second modified surface;
forming an adhesive layer over the first modified surface, the second modified surface, or the first modified surface and the second modified surface; and
adhering the first modified surface to the second modified surface through the adhesive layer.

2. The method of claim 1, wherein a gas of the first atmospheric environmental plasma treatment and a gas of the second atmospheric environmental plasma treatment are selected from the group consisting of air, nitrogen, oxygen, argon, carbon dioxide and a combination thereof.

3. The method of claim 1, wherein five seconds before performing the first atmospheric environmental plasma treatment and five seconds after performing the first atmospheric environmental plasma treatment, each of the surface of the ethyl vinyl acetate copolymer or the derivative thereof layer and the first modified surface has a temperature less than or equal to 70° C., and five seconds before performing the second atmospheric environmental plasma treatment and five seconds after performing the second atmospheric environmental plasma treatment, each of the surface of the thermoplastic elastomer layer and the second modified surface has a temperature less than or equal to 150° C.

4. The method of claim 1, wherein the adhesive layer comprises a material selected from the group consisting of acrylic resin, epoxy resin, hot melt adhesive, polyurethane, organic silicon and a combination thereof.

5. The method of claim 1, wherein an adhesive strength of the first modified surface to the second modified surface through the adhesive layer is greater than or equal to 2 kg/cm.

6. The method of claim 1, further comprising heating the adhesive layer before adhering the first modified surface to the second modified surface through the adhesive layer.

7. A laminate manufactured by the method of claim 1, wherein the laminate is consisting essentially of the ethyl vinyl acetate copolymer or the derivative thereof layer, the thermoplastic elastomer layer and the adhesive layer.

8. A laminate consisting essentially of an ethyl vinyl acetate copolymer or the derivative thereof layer, a thermoplastic elastomer layer and an adhesive layer, wherein the thermoplastic elastomer layer is on a side of the ethyl vinyl acetate copolymer or the derivative thereof layer, and the adhesive layer is between the ethyl vinyl acetate copolymer or the derivative thereof layer and the thermoplastic elastomer layer.

9. The laminate of claim 8, wherein each of a surface of the ethyl vinyl acetate copolymer or the derivative thereof layer and a surface of the thermoplastic elastomer layer has a functional group selected from the group consisting of a hydroxyl group, a carbonyl group, a carboxyl group, an aldehyde group, an amino group and a combination thereof.

10. The laminate of claim 8, wherein an adhesive strength of the ethyl vinyl acetate copolymer or the derivative thereof layer to the thermoplastic elastomer layer through the adhesive layer is greater than or equal to 2 kg/cm.
